(19) United States
(12) Patent Application Publication
(10) Pub. No.: US 2006/0152521 A1
(43) Pub. Date: Jul. 13, 2006

(54) Method, device and computer program for processing a computer aided polygon model

(76) Inventor: Juha Paaso, Vantaa (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/542,352

(22) PCT Filed: Jan. 16, 2004
(86) PCT No.: PCT/FI04/00023

§ 371 Date: Jul. 14, 2005

(30) Foreign Application Priority Data
Jan. 17, 2003 (FI) 20030075

(51) Int. Cl. G09G 5/00

(52) U.S. Cl. 345/581

(57) ABSTRACT

The invention relates to a procedure for processing a computer aided polygon model, based on the use of a linear vertex array and a linear index array. The polygon model part to be presented graphically is modified by changing the linear index array, while the linear vertex array remains unchanged. Advantages include an effective way to change the polygon model part to be presented graphically to correspond to the hardware requirements.

### FIELD

The invention relates to a method for processing a computer aided polygon model, a device for processing a computer aided polygon model, and a computer program for processing a polygon model.

### BACKGROUND

Computer aided graphics requires large computation and memory resources of the devices used. One way to decrease the need for said resources is to utilize in graphic representations different polygon models in which graphic structural entities are generated by means of image elements. Image elements may be triangles, for instance.

In computer applications according to the prior art, a polygon model is formed a vertex structure that may be, for example, or of an array, tree or list structure, the vertex structure containing the vertices of the image elements of the polygon model. In addition, an index data structure is formed that may be of an array, tree or list structure, the elements of the index data structure connecting the vertices contained in the vertex structure to the image elements of the polygon model. However, the polygon model must be modified, for example due to restricted computer resources. In the modification, image elements are removed from or added to the polygon model. In the prior art, modifying the polygon model is implemented by changing the number of image elements of the polygon model to be presented graphically by rearranging the elements of the vertex data structure in such a way that only the desired elements of the vertex data structure are presented graphically.

In solutions according to the prior art, the drawbacks include the heaviness of the processing of a vertex data structure, particularly at the display stage of graphic information. This causes a technical bottleneck for the speed of the processing of graphic information and restricts the size of the graphic information to be processed.

### BRIEF DESCRIPTION

An object of the invention is to implement an improved method for processing a computer aided polygon model, an improved device for processing a computer aided polygon model, and an improved computer program for processing a polygon model.

As an aspect of the invention, a method for processing a computer aided polygon model is provided. The method comprises forming a linear vertex array which is static and which contains the vertices of the image elements of the polygon model; forming a linear index array whose elements define the image elements of the polygon model by pointing at the vertices of each image element, and which linear index array comprises an active part, the image elements defined by the elements of the active part being included in the polygon model part to be presented graphically; and modifying the active part of the index array to change the image elements included in the polygon model part to be presented graphically while maintaining the linearity of the index array.

As an aspect of the invention, a device for processing a computer aided polygon model is provided. The device comprises a linear vertex array which is static and which contains the vertices of the image elements of the polygon model; a linear index array whose elements define the image elements of the polygon model by pointing at the vertices of each image element, and which linear index array comprises an active part, the image elements defined by the elements of the active part being included in the polygon model part to be presented graphically; and a modification unit to modify the active part of the index array to change the image elements included in the polygon model part to be presented graphically while maintaining the linearity of the linear index array.

As an aspect of the invention, a computer program for processing a polygon model is provided. The computer program comprises a linear vertex array which is static and which contains the vertices of the image elements of the polygon model; a linear index array whose elements define the image elements of the polygon model by pointing at the vertices of each image element, and which linear index array comprises an active part, the image elements defined by the elements of the active part being included in the polygon model part to be presented graphically; and computer-executable commands to modify the active part of the index array to change the image elements included in the polygon model part to be presented graphically while maintaining the linearity of the linear index array.

Preferred embodiments of the invention are described in the dependent claims.

The invention is based on modifying the polygon model part to be presented graphically by modifying the linear index array while the linear vertex array remains unchanged and the linear index array remains linear.

A plurality of advantages is achieved with the procedure according to the invention. With the procedure the size of the polygon model part to be presented graphically can be changed very quickly to correspond to the hardware requirements. The linear index array and the linear vertex array as the data structures used enable an effective representation form of the polygon model, whose modifications and graphic representation can be carried out efficiently.

### LIST OF FIGURES

The invention will now be described in greater detail in connection with preferred embodiments, referring to the attached drawings, in which

FIG. 1A shows a polygon model according to an embodiment of the presented solution;

FIG. 1B shows a polygon model according to another embodiment of the presented solution;

FIG. 2 shows a data structure according to an embodiment of the presented solution;

FIG. 3 shows a flow chart illustrating embodiments of the presented solution; and

FIG. 4 is a simple block diagram illustrating a device according to an embodiment of the presented solution.

### DESCRIPTION OF EMBODIMENTS

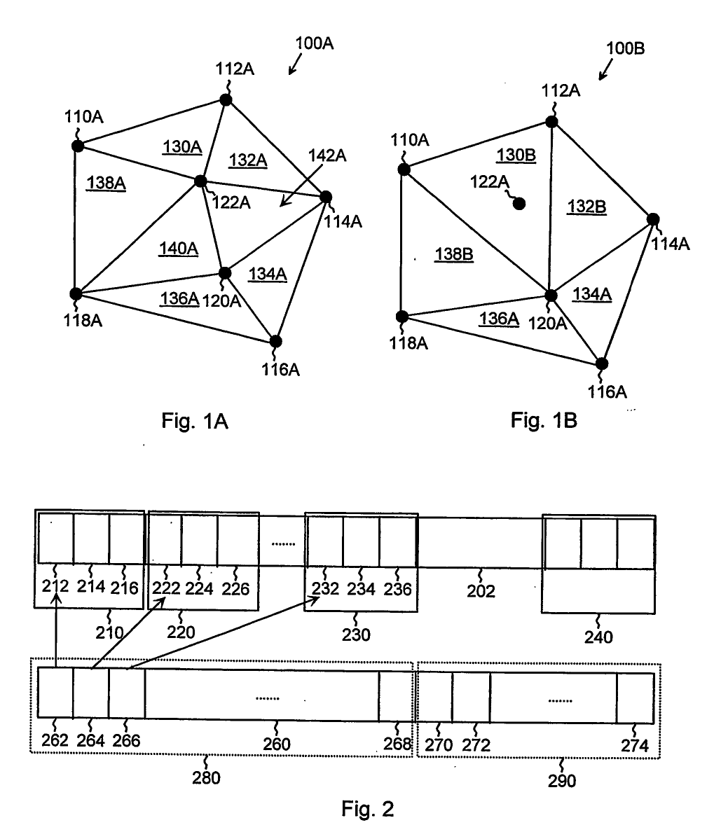

Referring to FIG. 1A, a polygon model 100A according to an embodiment of the presented solution is studied. In the presented example, a two-dimensional polygon model 100A is studied, the image elements 130A to 142A of which are triangles. A polygon model is a collection of image elements by means of which a desired graphic object, such as a geometric figure, is presented. The presented solution is not, however, restricted to a two-dimensional polygon model, but the model may also be a polygon model with more dimensions.

The image elements 130A, 132A, 134A, 136A, 138A, 140A, 142A of the polygon model 100A are defined by vertices 110A, 112A, 114A, 116A, 118A, 120A, 122A when the vertices 110A to 122A are connected in a desired manner. Each vertex 110A to 122A can function as the vertex for more than one image element 130A to 142A. The vertex is also known as an extreme point and the vertex array as an extreme point array.

FIG. 1B shows graphic representation 100B of the polygon model of FIG. 1A after the modification of the image elements of the polygon model 100A to be presented graphically. The vertices 110A to 122A of the polygon model have remained unchanged in the modification, but the connectivity information of the vertices 110A to 122A has changed in such a way that the vertex 122A is not, in FIG. 1B, connected to any of the image element. As a result of the modification, two triangles disappear from the polygon model part to be presented graphically, and the triangles 130A, 132A, 138A and 142A are replaced by the triangles 130B, 132B and 138B. Thus, the edge 120A to 122A associated with the vertex 122A of the polygon model 100A has collapsed, and the opening formed in the collapse of the edge has been filled by changing the connectivity information of the polygon model. As a result of the modification, the elaborateness of the polygon model has changed, but the visual appearance has remained recognizable. By correspondingly removing or adding vertices from the polygon model part to be presented and by changing the connectivity information of the vertices, the graphic manifestation of the polygon model may be elaborated or coarsened.

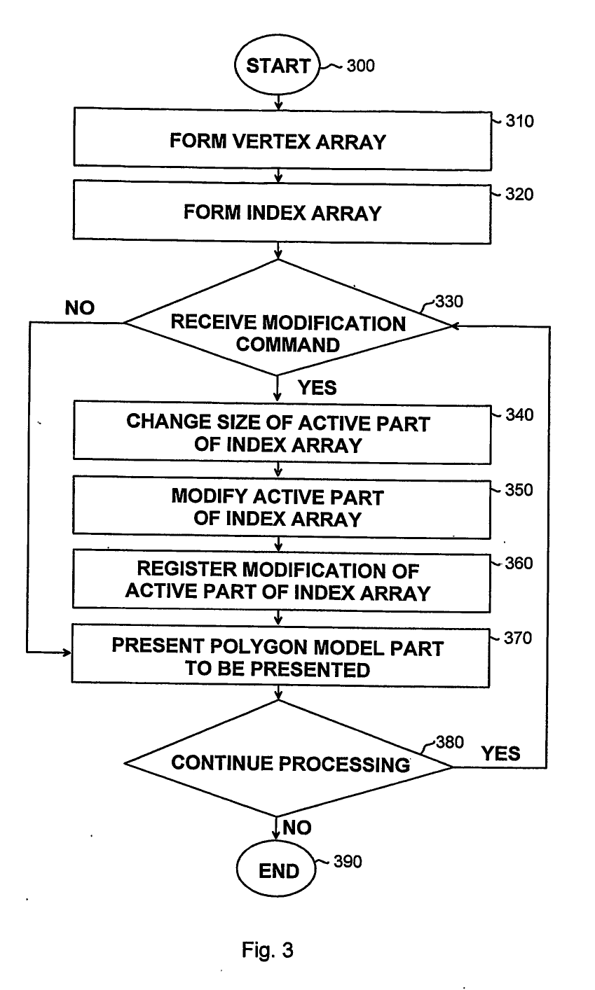

FIG. 3 shows embodiments of the method according to the presented method by means of a flow chart. The method is started in 300 and terminated in 390.

In the presented solution, the polygon model is provided by forming in 310 a linear vertex array which is static and which contains the vertices of the image elements of the polygon model. Further, in 320, a linear index array is formed whose elements define the image elements of the polygon model by pointing at the vertices of each image element, and which linear index array comprises an active part, the image elements defined by the elements of the active part being included in the polygon model part to be presented graphically. The polygon model part to be presented graphically determines the visual appearance of the polygon model. The image information used by the polygon model has originally been generated in a graphic application, for instance.

FIG. 2 illustrates an example of a linear vertex array 202, which contains the vertices 210, 220, 230 and 240 of the image elements of a three-dimensional polygon model. Each vertex 210, 220, 230 and 240 is formed of an x, y, and z vertex coordinate positioned successively in a known order relative to each other, whereby in order to point at each vertex 210, 220, 230, 240, information on the position of one vertex coordinate of the vertex 210, 220, 230, 240 in question in the linear vertex array 202 is sufficient. For example, the vertex coordinates of the vertex 210 are 212, 214 and 216. The vertices 210, 220, 230 and 240 may be located, relative to each other, at any point of the linear vertex array 202, as far as the location of the vertices 210, 220, 230, 240 is known. In an embodiment, the elements of the linear vertex array 202 are floating point numbers. The number of vertices 210, 220, 230, 240 depends on the size of the polygon model and the computer memory capacity used.

In the presented solution, the linear vertex array 202 is static. The linearity of the linear vertex array 202 means, in this context, that the vertex array 202 is a one-dimensional array whose elements form an uninterrupted data structure in the memory space. The linear vertex array 202 being static means, in this context, that the linear vertex array 202 remains unchanged when each polygon model is processed. Thus, the memory addressing of the vertex coordinate of each vertex 210, 220, 230, 240 in the linear vertex array 202 remains unchanged.

FIG. 2 shows an example of a linear index array 260, whose elements 262, 264, 266, 268, 270, 272, 274 define the image elements of the polygon model. Each element 262 to 274 of the index array 260 points at one of the vertices 210, 220, 230, 240 of the linear vertex array 202 in such a way that one edge of the image element to be associated to the specific element of the linear index array 260 is plotted through the vertex 210, 220, 230, 240 pointed at. Let us assume, for example, that a triangle-shaped image element is defined by the vertices 210, 230 and 240. Thus, the linear index array 260 has three references to the linear vertex array 202, and the image element is defined by means of a linear index array 260 in such a way that the element 262 of the linear index array 260, for instance, points at the memory location of the linear vertex array 202, which contains the coordinates 212, 214 and 216 of the vertex 210. Correspondingly, the element 264 of the linear index array 260, for instance, points at the memory location of the linear vertex array 202, which memory location returns the coordinates 222, 224 and 226 of the vertex 220. Further, the element 266 of the linear index array 260, for instance, points at the memory location of the linear vertex array 202, which memory location returns the coordinates 232, 234 and 236 of the vertex 230. In an embodiment, the elements of the index array 260 that define the same image element are positioned successively in the linear index array 260. The elements of the linear index array 260 are integer number variables.

The polygon model can be presented in the form (nᵥ, V, nₜ, I), where array V is a linear vertex array, I is a linear index array, index nₜ is the number of indices in the index array, and index nᵥ is the number of vertices in the vertex array.

In the presented solution, the linear index array 260 comprises an active part 280, the image elements defined by the elements 262 to 268 of the active part being included in the polygon model part to be presented graphically. The polygon model part to be presented graphically comprises those image elements that are shown in the graphic user interface of a computer or transmitted to another computer over an information network, for example.

In the presented solution, the active part 280 of the index array is modified in 350 to change the image elements included in the polygon model part to be presented graphically while maintaining the linearity of the linear index array 260.

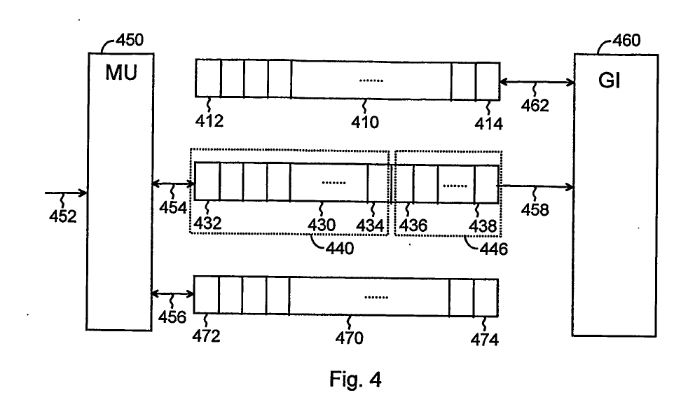

Referring to FIG. 4, a device for processing a computer aided polygon model according to the presented solution is studied. The device comprises a linear vertex array 410, a linear index array 430 and a modification unit 450. The vertex array 410 has the properties of the linear vertex array 202 shown in FIG. 2, comprising vertices 412, 414 that correspond to the vertices 210, 220, 230, 240 shown in FIG. 2. The linear index array 430 is similar to the linear index array 260 shown in FIG. 2, comprising elements 432, 434, 436, 438 that correspond to the elements 262 to 274 shown in the array of FIG. 2. The linear index array 430 comprises an active part 440, which is defined in the same way as the active part 280. The linear vertex array 410 and the linear index array 430 of the device may be implemented by means of random-access memory, for example, utilizing prior art techniques. Correspondingly, in a computer program the linear vertex array 410 and the linear index array 430 may be implemented by defining for the program code arrays that use computer memory blocks when a computer program is run.

A modification unit 450 is connected to the linear index array 430 via a memory bus 454, for example, and it carries out the modification of the active part 440 of the index array 430 to change the image elements 130A to 142A included in the polygon model part to be presented graphically while maintaining the linearity of the linear index array 430. The modification may also be carried out with a computer-executable command to modify the active part 440 of the index array 430 to change the image elements 130A, 142A included in the polygon model part to be presented graphically while maintaining the linearity of the linear index array 430.

In an embodiment, the polygon model part to be presented graphically is presented graphically in 370. Thus, the device comprises a graphic user interface 460, which is connected by means of a memory bus 458, for instance, to the linear index array 430. The graphic user interface presents graphically the polygon model part to be presented graphically. The graphic presentation may be implemented in such a way that the elements of the active part 440 of the linear index array are fed to the graphic card of the graphic user interface, which graphic card uses the elements in question for pointing at the memory locations of the vertex array 410 via a memory bus 462, for example. It is also possible that the graphic user interface is connected to a modification unit 450, via which the graphic information is transmitted from the linear index array 430 and linear vertex array 410 to the graphic user interface 460. Forming graphic representation may also be carried out with a computer-executable command.

In an embodiment, the active part 280 of the linear index array 260 is modified in 350 by replacing an element 262 to 274 of the linear index array 260 with another element 262 to 274 of the linear index array 260. Thus, the replacement taking place within the active part 280 does not change the size of the polygon model part to be presented graphically, but the connectivity information of the vertices changes, whereby also the visual appearance of the polygon model changes. The replacement may be carried out in the modification unit 450 for example with a computer-executable command.

In an embodiment, the linear vertex array 202, 410 contains each vertex 210, 220, 230, 240, 432, 434, 436, 438 only once. With this procedure, the memory space used by the linear vertex array 202, 410 relative to the information contained in the linear vertex array 202, 410 can be optimized.

In an embodiment, the linear index array 260 is formed in 320 in such a way that the linear index array 260 further comprises a passive part 290, the image elements defined by the elements 270, 272, 274 of the passive part belonging to the outside of the polygon model part to be presented graphically, and in 350 the active part 280 of the index array is modified by moving at least one element of the linear index array 260 between the active part 280 and the passive part 290. Thus, for example, the vertex 210 may be left outside the graphic representation by moving the element 262 of the index array 260 pointing at the vertex 210 to the passive part 290 of the linear index array 260. The linearity of the linear index array 260 can be maintained for instance by rearranging elements 264, 266, 268 of the active part 280 and by changing the size of the active part 280. Correspondingly, the size of the active part 280 can be increased by moving elements from the passive part 290 to the active part 280. Thus, the visual appearance of the polygon model becomes more accurate when the image elements to be presented graphically increase.

Referring to the figure, a case similar to that shown in FIGS. 1A and 1B is studied, in which the polygon model part to be presented graphically is modified by removing elements of the linear index array 260 from the active part 280 to the passive part 290. Let us assume that the vertex 122A of FIG. 1A is determined by the vertex 210 of the linear vertex array 202. Thus, the vertex coordinates are 212, 214, 216, which are pointed at by the element 262 of the linear index array in the way shown in FIG. 2. The vertex 122A is removed from the polygon model part to be presented graphically by moving the element 262 from the polygon model part to be presented graphically to the end of the linear index array 260. Thus, the element 262 is in the passive part 290, and the vertex 210, 122A pointed at by the element in question is not plotted. The linearity of the linear index array 260 is maintained by decreasing the size of the active part 280 by one and by increasing the size of the passive part 290 by one, and by filling the gap generated by moving the element 262. In an embodiment, the polygon model part to be presented graphically is modified by moving at the same time all elements of the linear index array 260 defining the same image element between the active part 280 and the passive part. Thus, the group of the elements 262, 264, 266 is moved and patched up in the above-described manner.

In the device, forming the passive part 446 can be carried out in the modification unit 450 by determining the index or group of indexes of a computer-executable command, for example, which determine the memory space of the passive part 446. Moving at least one element of the linear index array 430 between the active part 440 and the passive part 446 can be carried out in the modification unit 450 in such a way that the modification unit 450 attends to the required read and write measures of the memory locations, for instance by means of computer-executable commands. Correspondingly, the linearity of the linear index array 430 can be maintained by means of an algorithm programmed to the modification unit 450.

In an embodiment, the active part 280 is formed in the memory space in such a way that the active part 280 forms a linear memory block, whose first and last memory addresses are known, and the passive part 290 forms a linear memory block after the active part 280 in such a way that the linear index array 260 fills a uniform memory space. Thus, the polygon model part to be presented graphically can be picked up from the linear index array 280 by knowing only the beginning of the active part 280 in the memory space and the index that determines the size of the active part 280. Said property significantly speeds up the functioning of the display adapter of a computer, for example.

In an embodiment, the modification of the linear index array 260 is registered in 360 in such a way that the linear index array 260 is restorable to the state preceding the modification. A change array may be formed for the registering, to which array the modifications of the linear index array 260 are stored. The change array can be presented in the following form:
S=[(i, fₐ), (j, f_{b}), . . . , (k, f_{c})] (1)
where indices i, j and k refer to the indices of the linear index array, and elements fₐ, f_{b} and f_{c} are elements removed from the memory locations i, j and k. If, for example i=0 and fₐ=5, the original value of the first element of the linear index array 260 has been 5. FIG. 4 shows the change array 470 of the device, connected to the modification unit 450 by means of a memory bus 456, for example. The change array 470 comprises elements 472 to 474, which correspond to pairs (i, fₐ) of Formula 1. The change array may also be formed with a computer program, which forms a memory block corresponding to the change array 470 in the memory space of the device used.

In an embodiment, a modification command is received in 330 to modify the active part 280 of the linear index array 260, and in 340 the size of the active part 280 of the linear index array 260 is changed on the basis of the modification command. FIG. 4 shows a modification command 452, which is received in the modification unit 450. The modification command 452 may be formed in a graphic card of a computer, for example.

In an embodiment, the modification command to modify the active part 280 of the linear index array 260 is received in 330, and in 350 the active part 280 of the linear index array 260 is modified on the basis of the modification command.

If no modification command is received, the polygon model part to be presented graphically remains as such, whereby the visual appearance of the polygon model remains unchanged. If a modification command is received, method steps according to blocks 340, 350, 360, 370, 380 shown in FIG. 3 can be performed.

The measures according to the modification command 452 are performed in the modification unit 450, for example by means of computer-executable commands.

In an embodiment, the modification command comprises a data structure C that can be presented in the following form:
C=[nₜ, T, n_{S}, S, v], (1)
where nₜ is the number of polygons to be removed from the polygon model part to be presented graphically; T is, in the form of integer number indices, the list of polygons to be removed from the polygon model part to be presented graphically to the linear index list 260; nₛ is the number of indices to be changed in the linear index list 260; S is the change array shown in FIG. 1; and v is an index to which the elements of the change array S are changed.

The purpose of the modification command is to perform the modification of the polygon model part to be presented graphically in such a way that the visual manifestation of the polygon model changes as desired. The polygon model part to be presented graphically determines, for instance, the load set for the computer graphics, which load can be adjusted by modifying the size of the polygon model or the polygon model part to be presented graphically. For example in the transformation of CAD images (CAD, Computer Aided Design), such as rotation, mathematical operations are directed at the vertices of the vertex array, which operations may grow computationally very heavy in the case of great polygon models. Thus, image elements of the polygon model part to be presented graphically must be removed, whereby the accuracy of the visual manifestation of the polygon model is weakened.

The image elements to be modified are determined by the error metrics used that selects the image elements to be modified by using criteria characteristic of the error metrics in question. In a general case, the error metrics assesses the significance of the image elements for the graphic appearance of the polygon model part to be presented graphically and determines data structure C of FIG. 2, which contains the information relating to the changes to be directed at the linear index array 260. The error metrics as such is a science of its own, so that it will not be dealt with in more detail in this context. Error metrics is described in greater detail for example in publication by M. Garland and Paul Heckbert: “Surface Simplification Using Quadratic Error Metrics” in Proceedings of SIGGRAPH 97.

The method according to the presented solution and its different embodiments can be repeated until the decision is made in 380 on continuing or interrupting the processing.

The device for processing a computer aided polygon model, shown in FIG. 3, can be implemented for instance as part of the display adapter of a computer, display adapter of a digital television or display adapter of a terminal in a radio system. The above display adapters may be considered to have a digital computer comprising the following main parts: a central processing unit (CPU) and a working memory. The central processing unit comprises three main parts: registers, an arithmetic-logical unit and a control unit. The data structures and programs needed in the processing can be implemented with different programming languages. Configuration can be implemented by programming, i.e. preparing software and data structures containing the required functionality, but also pure hardware solutions for instance with integrated circuits are feasible. Also mixed operation is feasible, where certain functionalities are implemented as hardware implementation, whereas part is implemented by software. When selecting the manner of implementation, a person skilled in the art will take into account the criteria set for, for instance, the size and price of the device, as well as other factors.

The computer program according to the invention can be stored and transmitted by using different transmitting means and mass memories. These include, for example, the Internet, hard disks, optical record disks, such as CD (Compact Disk), memory cards and magnetic tapes.

Although the invention is described above with reference to the example according to the attached drawings, it is obvious that the invention is not restricted to it but can be modified in a plurality of ways within the scope of the attached claims.

1. A method for processing a computer aided polygon model, comprising:
forming a linear vertex array which is static and which contains the vertices of the image elements of the polygon model;
forming a linear index array whose elements define the image elements of the polygon model by pointing at the vertices of each image element, and which linear index array comprises an active part, the image elements defined by the elements of the active part being included in the polygon model part to be presented graphically; and
modifying the active part of the index array to change the image elements included in the polygon model part to be presented graphically while maintaining the linearity of the index array.

2. A method according to claim 1, further comprising presenting graphically the polygon model part to be presented graphically.

3. A method according to claim 1, further comprising modifying the active part of the linear index array by replacing an element of the linear index array with another element of the linear index array.

4. A method according to claim 1, further comprising forming the linear vertex array in such a way that each vertex appears in the vertex array only once.

5. A method according to claim 1, further comprising forming a linear index array in such a way that the linear index array further comprises a passive part, the image elements defined by the elements of the passive part belonging to the outside of the polygon model part to be presented graphically; and
modifying the active part of the linear index array by moving at least one element of the linear index array between the active part and the passive part.

6. A method according to claim 1, further comprising registering the modification of the linear index array in such a way that the linear index array is restorable to the state preceding the modification.

7. A method according to claim 1, further comprising receiving a modification command to modify the active part of the linear index array; and
changing the size of the active part of the linear index array on the basis of the modification command.

8. A method according to claim 1, further comprising receiving a modification command to modify the active part of the linear index array; and
modifying the active part of the linear index array on the basis of the modification command.

9. A device for processing a computer aided polygon model, comprising:
a linear vertex array which is static and which contains the vertices of the image elements of the polygon model;
a linear index array whose elements define the image elements of the polygon model by pointing at the vertices of each image element, and which linear index array comprises an active part, the image elements defined by the elements of the active part being included in the polygon model part to be presented graphically; and
a modification unit to modify the active part of the index array to change the image elements included in the polygon model part to be presented graphically while maintaining the linearity of the linear index array.

10. A device according to claim 9, further comprising a graphic user interface for presenting graphically the polygon model part to be presented graphically.

11. A device according to claim 9, wherein the modification unit is configured to replace an element of the linear index array with another element of the linear index array.

12. A device according to claim 9, wherein the linear vertex array contains each vertex only once.

13. A device according to claim 9, wherein the linear index array further comprises a passive part, the image elements defined by the elements of the passive part belonging to the outside of the polygon model part to be presented graphically; and
wherein the modification unit is configured to move at least one element of the linear index array between the active part and the passive part.

14. A device according to claim 9, further comprising a change array for registering the modification of the linear index array in such a way that the linear index array is restorable to the state preceding the modification.

15. A device according to claim 9, wherein the modification unit is configured to receive a modification command to modify the active part of the linear index array; and
wherein the modification unit is configured to change the size of the active part of the linear index array on the basis of the modification command.

16. A device according to claim 9, wherein the modification unit is configured to receive a modification command to modify the active part of the linear index array; and
wherein the modification unit is configured to modify elements of the active part of the linear index array on the basis of the modification command.

17. A computer program for processing a polygon model, comprising:
a linear vertex array which is static and which contains the vertices of the image elements of the polygon model;
a linear index array whose elements define the image elements of the polygon model by pointing at the vertices of each image element, and which linear index array comprises an active part, the image elements defined by the elements of the active part being included in the polygon model part to be presented graphically; and
computer-executable commands for modifying the active part of the index array to change the image elements included in the polygon model part to be presented graphically while maintaining the linearity of the linear index array.

18. A computer program according to claim 17, further comprising computer-executable commands for presenting graphically the polygon model part to be presented graphically.

19. A computer program according to claim 17, further comprising computer-executable commands to replace an element of the linear index array with another element of the linear index array.

20. A computer program according to claim 17, wherein the linear vertex array comprises each vertex only once.

21. A computer program according to claim 17, wherein the linear index array further comprises a passive part, the image elements defined by the elements of the passive part belonging to the outside of the polygon model part to be presented graphically; and
wherein the computer program further comprises computer-executable commands to move at least one element of the linear index array between the active part and the passive part.

22. A computer program according to claim 17, further comprising a change array to register the modification of the linear index array in such a way that the linear index array is restorable to the state preceding the modification.

23. A computer program according to claim 17, further comprising:
computer-executable commands to receive a modification command to modify the active part of the linear index array; and
computer-executable commands to change the size of the active part of the linear index array on the basis of the modification command.

24. A computer program according to claim 17, further comprising:
computer-executable commands to receive a modification command to modify the active part of the linear index array; and
computer-executable commands to modify the active part of the linear index array on the basis of the modification command.
